(19) United States
(12) Patent Application Publication
(10) Pub. No.: US 2005/0118504 A1
(43) Pub. Date: Jun. 2, 2005

(54) Energy device and method for producing the same

(75) Inventors: Kazuyoshi Honda, Takatsuki-shi (JP); Kiichiro Oishi, Kyoto-shi (JP); Yasuhiko Bito, Minamikawachi-gun (JP); Takayuki Nakamoto, Sakai-shi (JP)

Correspondence Address: MERCHANT & GOULD PC, P.O. BOX 2903, MINNEAPOLIS, MN, 55402-0903, US

(73) Assignee: Matsushita Electric Industrial Co., Ltd., Kadoma-shi (JP)

(21) Appl. No.: 10/985,543

(22) Filed: Nov. 10, 2004

(30) Foreign Application Priority Data
Nov. 27, 2003 (JP) 2003-397567

(51) Int. Cl. H01M 4/58; B05D 5/12; H01M 4/66; H01M 4/04

(52) U.S. Cl. 429/218.1; 427/58; 29/623.5; 429/245

(57) ABSTRACT

An auxiliary film-forming source containing a main component element of a collector and a negative active material film-forming source for forming a negative active material thin film are placed adjacent to each other so that parts of film-forming particles from the respective sources are mixed with each other. The collector is moved relatively from the auxiliary film-forming source side to the negative active material film-forming source side, whereby a negative active material thin film containing silicon as a main component is formed on the collector by a vacuum film-forming process. A composition gradient layer, in which a composition distribution of a main component element of the collector and silicon constituting the negative active material is varied smoothly, is formed at the interface between the negative active material thin film and the collector. Even when the silicon particles in the negative active material expand/contract during charging/discharging, the composition gradient layer alleviates the strain involved in the expansion/contraction of the silicon particles, so that peeling at the interface between the negative active material thin film and the collector is suppressed, and the adhesion strength is enhanced. Consequently, cycle characteristics are enhanced.

### BACKGROUND OF THE INVENTION

1. Field of the Invention

The present invention relates to an energy device and a method for producing the same.

2. Description of the Related Art

A lithium ion secondary battery includes a negative collector, a negative active material, an electrolyte, a separator, a positive active material, and a positive collector as main components. The lithium ion secondary battery plays a great role as an energy source for mobile communication equipment and various kinds of AV equipment. Along with miniaturization and enhanced performance of equipment, the miniaturization and the increase in energy density of the lithium ion secondary battery are proceeding. Thus, significant efforts are being put into improving each element constituting the battery.

For example, JP8(1996)-78002A discloses that the energy density can be increased by using, as a positive active material, an amorphous oxide obtained by melting a mixed powder of a particular transition metal oxide by heating, followed by rapid cooling.

Furthermore, JP2000-12092A discloses that the battery capacity and cycle life can be enhanced by using a transition metal oxide containing lithium as a positive active material, using a compound containing silicon atoms as a negative active material, and setting the weight of the positive active material to be larger than that of the negative active material.

Furthermore, JP2002-83594A discloses that an amorphous silicon thin film is used as a negative active material. Due to the use of the amorphous silicon thin film, a larger amount of lithium ions can be absorbed compared with the case of using carbon, so that an increase in capacity is expected.

JP2001-266851A describes the following. In formation of a negative active material on a negative collector, the negative active material is formed at such a temperature that a mixed layer, in which a negative collector component diffuses, is formed in the negative active material in the vicinity of an interface between the negative collector and the negative active material. Due to the mixed layer, the adhesion between the negative collector and the negative active material becomes satisfactory, whereby an electrode for a lithium ion secondary battery having a high charging/discharging capacity and excellent charging/discharging cycle characteristics is obtained.

In an energy device, the enhancement of battery capacity and cycle characteristics is a particularly important object; however, it may be considered that the above-mentioned conventional techniques have not achieved the object sufficiently.

The cycle characteristics are influenced greatly by the adhesion strength at the interface between the collector and the active material. In JP2001-266851A, although the adhesion strength is enhanced by forming a mixed layer at the interface, it is necessary to control the temperature during formation of the negative active material, which results in difficulty in an industrial application.

Thus, the chemical approach for realizing excellent cycle characteristics is not still sufficient, and there is a demand for the establishment of a high-performance silicon negative electrode.

### SUMMARY OF THE INVENTION

The object of the present invention is to provide an energy device with satisfactory cycle characteristics and a method for producing the same, which can be obtained by a simple procedure.

In order to achieve the above-mentioned object, a first method for producing an energy device of the present invention includes forming a negative active material thin film, containing silicon as a main component, on a collector by a vacuum film-forming process. With respect to an auxiliary film-forming source containing a main component element of the collector and a negative active material film-forming source for forming the negative active material thin film, placed adjacent to each other so that parts of film-forming particles from the respective sources are mixed with each other, the collector is moved relatively from the auxiliary film-forming source side to the negative active material film-forming source side.

A first energy device of the present invention includes a collector and a negative active material thin film containing silicon as a main component. With respect to an auxiliary film-forming source containing a main component element of the collector and a negative active material film-forming source for forming the negative active material thin film, placed adjacent to each other so that parts of film-forming particles from the respective sources are mixed with each other, the collector is moved relatively from the auxiliary film-forming source side to the negative active material film-forming source side, whereby the negative active material thin film is formed on the collector by a vacuum film-forming method.

Furthermore, a second method for producing an energy device of the present invention includes forming a negative active material thin film, containing silicon as a main component, on an electrolyte formed on a substrate by a vacuum film-forming process. With respect to a negative active material film-forming source for forming the negative active material thin film and a collector film-forming source for forming the collector, placed adjacent to each other so that parts of film-forming particles from the respective sources are mixed with each other, the substrate is moved relatively from the negative active material film-forming source side to the collector film-forming source side.

A second energy device of the present invention includes an electrolyte, a negative active material thin film containing silicon as a main component, and a collector. With respect to a negative active material film-forming source for forming the negative active material thin film and a collector film-forming source for forming the collector, placed adjacent to each other so that parts of film-forming particles from the respective sources are mixed with each other, the electrolyte is moved relatively from the negative active material film-forming source side to the collector film-forming source side, whereby the negative active material thin film and the collector are formed on the electrolyte by a vacuum film-forming method.

These and other advantages of the present invention will become apparent to those skilled in the art upon reading and understanding the following detailed description with reference to the accompanying figures.

### BRIEF DESCRIPTION OF THE DRAWINGS

FIG. 1 is a cross-sectional view showing a schematic configuration of one embodiment of an apparatus used for producing an energy device of the present invention.

FIG. 2 is an element distribution diagram in a thickness direction of a negative active material thin film of Example 1 of the present invention.

FIG. 3 is an element distribution diagram in a thickness direction of a negative active material thin film of Example 2 of the present invention.

FIG. 4 is an element distribution diagram in a thickness direction of a negative active material thin film of Comparative Example 1.

FIG. 5 is a schematic cross-sectional view showing an exemplary configuration of main portions of an energy device according to Embodiment 2 of the present invention.

FIG. 6 is a schematic cross-sectional view showing an exemplary product form of the energy device according to Embodiment 2 of the present invention.

FIG. 7 is a schematic perspective view of the product form of the energy device shown in FIG. 6.

FIG. 8 is a schematic cross-sectional view showing another exemplary product form of the energy device according to Embodiment 2 of the present invention.

FIG. 9A is a plan view showing an example of a fuse portion in the energy device of the present invention, and FIG. 9B is a cross-sectional view seen in an arrow direction taken along a line 9B-9B in FIG. 9A.

FIG. 10 is a cross-sectional view showing a schematic configuration of another embodiment of an apparatus used for producing the energy device of the present invention.

### DESCRIPTION OF THE PREFERRED EMBODIMENTS

According to the first and second energy devices and the first and second production methods of the present invention, an energy device with satisfactory cycle characteristics can be provided.

As in the above-mentioned first and second production methods, by performing continuous mixed film-formation using two film-forming sources, a composition gradient layer, in which a composition distribution of the main component element of the collector and silicon constituting the negative active material is varied smoothly, is formed at the interface between the negative active material thin film and the collector. Thus, even when the negative active material absorbs/desorbs ions during charging/discharging, thereby allowing silicon particles in the negative active material to expand/contract, since the composition gradient layer alleviates the strain involved in the expansion/contraction of the silicon particles, peeling at the interface between the negative active material thin film and the collector can be suppressed. In this manner, the adhesion strength at the interface between the negative active material thin film and the collector is enhanced, so that an energy device with cycle characteristics enhanced can be provided.

The composition gradient layer in the vicinity of the interface between the negative active material thin film and the collector, in which a composition distribution of the main component element of the collector and silicon is varied smoothly, is formed by the above-mentioned continuous mixed film-formation. When a third layer is merely inserted between the negative active material thin film and the collector, boundaries with a discontinuous composition are formed between the third layer and the negative active material thin film and between the third layer and the collector, and the force caused by the strain due to the expansion/contraction of silicon particles is concentrated in the boundaries, which makes it impossible to obtain satisfactory cycle characteristics.

As described above, JP2001-266851A describes the following. In formation of a negative active material on a negative collector, the negative active material is formed at such a temperature that a mixed layer, in which a negative collector component diffuses, is formed in the negative active material in the vicinity of an interface between the negative collector and the negative active material. In this case, the substrate temperature condition is limited to a high temperature, and it is necessary to control a temperature strictly. In contrast, according to the method for producing an energy device of the present invention, the negative active material thin film only needs to be formed by continuous mixed film-formation, resulting in satisfactory productivity.

Furthermore, according to the above-mentioned second production method, the collector also can be formed simultaneously with the negative active material thin film by a vacuum film-forming process, which is very efficient.

In the above-mentioned first and second production methods, “containing silicon as a main component” means that the content of silicon is 50 at % or more. The content of silicon is desirably 70 at % or more, more desirably 80 at % or more, and most desirably 90 at % or more. As the content of silicon in the negative active material thin film becomes higher, the battery capacity can be increased more.

In the above-mentioned first and second production methods, the “vacuum film-forming process” includes various kinds of vacuum thin film production processes such as vapor deposition, sputtering, chemical vapor deposition (CVD), ion plating, laser abrasion, and the like. Depending upon the kind of a thin film, an appropriate film-forming process can be selected. A thinner negative active material thin film can be produced more efficiently by a vacuum film-forming process. As a result, a small and thin energy device is obtained. Furthermore, the “film-forming particles” refer to particles, such as atoms, molecules, or a cluster, that are released from film-forming sources in these vacuum film-forming processes, and adhere to a film-formation surface to form a thin film.

In the above-mentioned first and second production methods, it is preferable that the vacuum film-forming process is vacuum vapor deposition. According to this configuration, a negative active material thin film of high quality can be formed stably and efficiently.

Furthermore, in the above-mentioned first production method, the “main component element of a collector” refers to an element contained in the collector in an amount of 50 at % or more.

It is preferable that the main component element of the collector is copper. According to this configuration, an energy device can be produced easily at a low cost.

Furthermore, in the above-mentioned second production method, it is preferable that the collector film-forming source contains copper as a main component. According to this configuration, an energy device can be produced easily at a low cost. Herein, “containing copper as a main component” means that the content of copper is 50 at % or more. The content of copper is desirably 70 at % or more, more desirably 80 at % or more, and most desirably 90 at % or more.

In the above-mentioned first and second production methods, it may be preferable that a part of silicon contained in the negative active material thin film is an oxide. The oxide of silicon as used herein does not include an oxide of silicon contained in boundary portions between the negative active material thin film and the other layers. This means that an oxide of silicon is contained in an intermediate region excluding upper and lower boundary portions of the negative active material thin film in a thickness direction. In the case where a content of silicon in the negative active material thin film is large, and a battery capacity is large, the degree of expansion/contraction of silicon particles during charging/discharging is high, which may degrade cycle characteristics. When the negative active material thin film contains an oxide of silicon, since the oxide of silicon expands/contracts less during charging/discharging, the expansion/contraction of the silicon particles during charging/discharging can be suppressed, and cycle characteristics can be enhanced.

Hereinafter, embodiments of the present invention will be described with reference to the drawings.

### Embodiment 1

An energy device according to Embodiment 1 of the present invention will be described.

The energy device of Embodiment 1 has the following configuration. A cylindrical winding body, in which a positive collector with a positive active material formed on both surfaces thereof, a separator, and a negative collector with a negative active material formed on both surfaces thereof are wound so that the separator is placed between the positive collector and the negative collector, is placed in a battery can, and the battery can is filled with an electrolyte solution.

As the positive collector, a foil, a net, or the like (thickness: 10 to 80 μm) made of Al, Cu, Ni, or stainless steel can be used. Alternatively, a polymer substrate made of polyethylene terephthalate, polyethylene naphthalate, or the like, with a metal thin film formed thereon also can be used.

The positive active material is required to allow lithium ions to enter therein or exit therefrom, and can be made of a lithium-containing transition metal oxide containing transition metal such as Co, Ni, Mo, Ti, Mn, V, or the like, or a mixed paste in which the lithium-containing transition metal oxide is mixed with a conductive aid such as acetylene black and a binder such as nitrile rubber, butyl rubber, polytetrafluoroethylene, polyvinylidene fluoride, or the like.

As the negative collector, a foil, a net, or the like (thickness: 10 to 80 μm) made of Cu, Ni, or stainless steel can be used. Alternatively, a polymer substrate made of polyethylene terephthalate, polyethylene naphthalate, or the like, with a metal thin film formed thereon also can be used.

The separator preferably has excellent mechanical strength and ionic permeability, and can be made of polyethylene, polypropylene, polyvinylidene fluoride, or the like. The pore diameter of the separator is, for example, 0.01 to 10 μm, and the thickness thereof is, for example, 5 to 200 μm.

As the electrolyte solution, a solution obtained by dissolving an electrolyte salt such as LiPF₆, LiBF₄, LiClO₄, or the like in a solvent such as ethylene carbonate, propylene carbonate, methyl ethyl carbonate, methyl acetate hexafluoride, tetrahydrofuran, or the like, can be used.

As the battery can, although a metal material such as stainless steel, iron, aluminum, nickel-plated steel, or the like can be used, a plastic material also can be used depending upon the use of a battery.

The negative active material is a silicon thin film containing silicon as a main component. The silicon thin film preferably is amorphous or microcrystalline, and can be formed by a vacuum film-forming process such as sputtering, vapor deposition, or CVD.

### EXAMPLES 1-2, AND COMPARATIVE EXAMPLE 1

Examples corresponding to Embodiment 1 will be described.

First, a method for producing a positive electrode will be described. Li₂CO₃ and CoCO₃ were mixed in a predetermined molar ratio, and synthesized by heating at 900° C. in the atmosphere, whereby LiCoO₂ was obtained. LiCoO₂ was classified to 100-mesh or less to obtain a positive active material. Then, 100 g of the positive active material, 10 g of carbon powder as a conductive agent, 8 g of polyethylene tetrafluoride dispersion as a binder, and pure water were mixed to obtain a paste. The paste containing the positive active material was applied to both surfaces of a band-shaped aluminum foil (thickness: 15 μm) as a positive collector, followed by drying, whereby a positive electrode was obtained.

Using a band-shaped copper foil (thickness: 30 μm) as a negative collector, a silicon thin film was formed as a negative active material on both surfaces of the copper foil by sputtering. This will be described in detail later.

As a separator, band-shaped porous polyethylene (thickness: 25 μm) with a width larger than those of the positive collector and the negative collector was used.

A positive lead made of the same material as that of the positive collector was attached to the positive collector by spot welding. Furthermore, a negative lead made of the same material as that of the negative collector was attached to the negative collector by spot welding.

The positive electrode, the negative electrode, and the separator obtained as described above were laminated so that the separator was placed between the positive electrode and the negative electrode, and wound in a spiral shape. An insulating plate made of polypropylene was provided for the upper and lower surfaces of the cylindrical winding body thus obtained, and the resultant cylindrical winding body was placed in a bottomed cylindrical battery can. A stepped portion was formed in the vicinity of an opening of the battery can. Thereafter, as a non-aqueous electrolyte solution, an isosteric mixed solution of ethylene carbonate and diethyl carbonate, in which LiPF₆ was dissolved in a concentration of 1×10³ mol/m³, was injected into the battery can, and the opening was sealed with a sealing plate to obtain a lithium ion secondary battery.

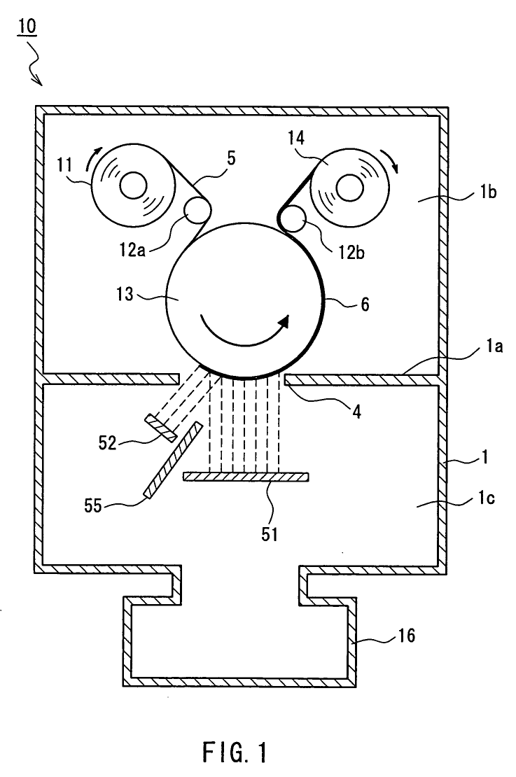

A method for forming a silicon thin film as the negative active material will be described with reference to FIG. 1.

A vacuum film-forming apparatus 10 shown in FIG. 1 includes a vacuum tank 1 partitioned into an upper portion and a lower portion by a partition wall 1a. In a chamber (transportation chamber) 1b on an upper side of the partition wall 1a, an unwinding roll 11, a cylindrical can roll 13, a take-up roll 14, and transportation rolls 12a, 12b are placed. In a chamber (thin film forming chamber) 1c on a lower side of the partition wall 1a, a sputtering film-forming source 51, an auxiliary sputtering film-forming source 52, and a mobile shielding plate 55 are placed. At a center of the partition wall 1a, a mask 4 is provided, and a lower surface of the can roll 13 is exposed to the thin film forming chamber 1c side via the opening of the mask 4. The inside of the vacuum tank 1 is maintained at a predetermined vacuum degree with a vacuum pump 16.

A band-shaped negative collector 5 unwound from the unwinding roll 11 is transported successively by the transportation roll 12a, the can roll 13, and the transportation roll 12b, and taken up around the take-up roll 14. During this process, particles (film-forming particles; hereinafter, referred to as “sputtering particles”) such as atoms, molecules, or a cluster generated from the auxiliary sputtering film-forming source 52 and the sputtering film-forming source 51 pass through the mask 4 of the partition wall 1a, and adhere to the surface of the negative collector 5 running on the can roll 13, thereby forming a thin film 6. The auxiliary sputtering film-forming source 52, the mobile shielding plate 55, and the sputtering film-forming source 51 are placed so as to be opposed to the negative collector 5 from an upstream side to a downstream side in the transportation direction of the negative collector 5. The mobile shielding plate 55 can move in a radius direction with respect to a rotation central axis of the can roll 13. The distance of the mobile shielding plate 55 from an outer circumferential surface of the can roll 13 was adjusted so that a part of sputtering particles from the auxiliary sputtering film-forming source 52 and a part of sputtering particles from the sputtering film-forming source 51 are mixed with each other in the vicinity of the outer circumferential surface of the can roll 13. Accordingly, first, the sputtering particles from the auxiliary sputtering film-forming source 52 mainly are deposited on the surface of the negative collector 5; thereafter, the ratio of the sputtering particles from the sputtering film-forming source 51 is increased gradually; and finally, the sputtering particles from the sputtering film-forming source 51 mainly are deposited.

In Example 1, using the above-mentioned apparatus, silicon was sputtered with argon ions in the sputtering film-forming source 51, whereby a silicon thin film (thickness: 8 μm) was formed on a copper foil as the negative collector 5. The deposition rate of the silicon thin film was set to be about 2 nm/s. As the sputtering film-forming source 51, a DC magnetron sputter source was used. Simultaneously, copper was sputtered with argon ions in the auxiliary sputtering film-forming source 52. The deposition amount of copper was set to be the same as that for sputtering only copper to form a thin film having a thickness of 50 nm.

In Example 2, copper was evaporated using an auxiliary evaporation source of a resistance heating system, in place of the auxiliary sputtering film-forming source 52. The deposition amount of copper was set to be the same as that for vapor-depositing only copper to form a thin film having a thickness of 2 μm. A negative active material thin film was formed in the same way as in Example 1 except for the above.

In Comparative Example 1, a negative active material thin film was formed in the same way as in Example 1, except that the auxiliary sputtering film-forming source 52 was not used.

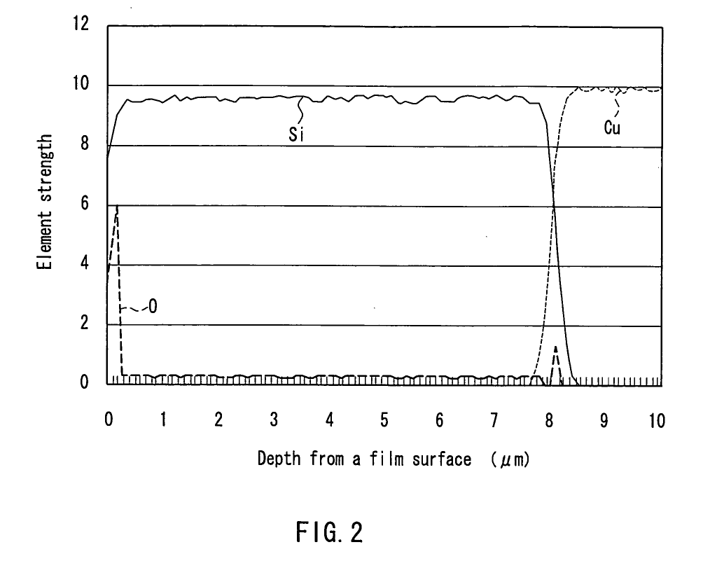

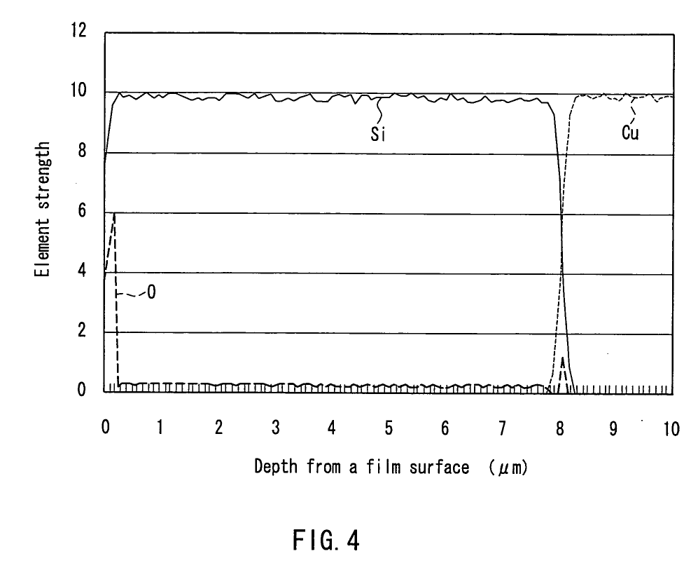

FIGS. 2, 3, and 4 show Auger depth profiles of the silicon thin films (negative active material thin films) of Examples 1 and 2, and Comparative Example 1. The Auger depth profile was measured with SAM 670 produced by Philips Co., Ltd. The Auger depth profile was measured at an acceleration voltage of an electron gun of 10 kV, an irradiation current of 10 nA, an acceleration voltage of an ion gun for etching of 3 kV, and a sputtering rate of 0.17 nm/s. “Depth from a film surface” represented by the horizontal axis in FIGS. 2 to 4 was obtained by converting the sputter etching time of a sample into an etching depth in a thickness direction, using a sputtering rate obtained by measuring the level difference formed by sputter-etching the same Si film and Cu film as those of the sample with a level difference measuring apparatus.

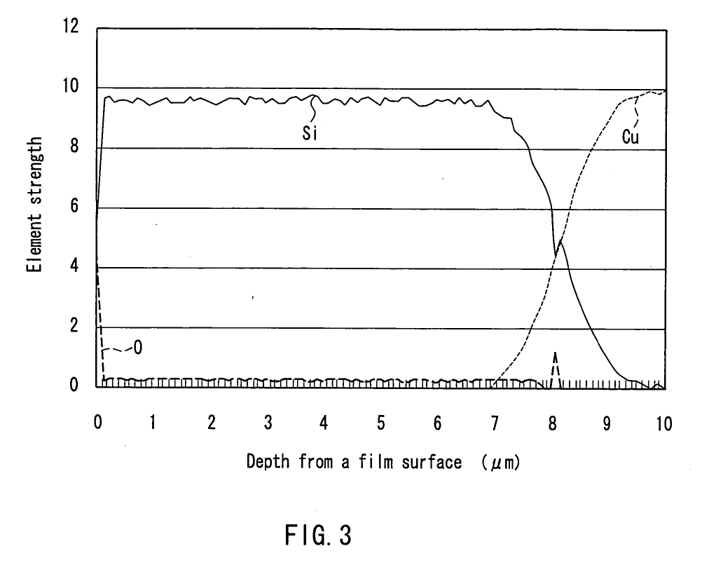

As is understood from FIGS. 2 to 4, in Examples 1 and 2 (FIGS. 2 and 3), in an initial stage of forming a negative active material thin film, by performing continuous mixed film-formation using two film-forming sources, a composition gradient layer, in which silicon and a main component element (copper) of a negative collector are mixed, and a composition distribution of these elements is varied smoothly, is formed at the interface between the negative collector and the negative active material.

The lithium ion secondary batteries formed in Examples 1 and 2, and Comparative Example 1 were subjected to a charging/discharging cycle test at a test temperature of 20° C., a charging/discharging current of 3 mA/cm², and a charging/discharging voltage range of 4.2 V to 2.5 V. The ratios of the discharging capacity after 50 cycles and 200 cycles, with respect to the initial discharging capacity, were obtained as battery capacity maintenance ratios (cycle characteristics). Table 1 shows the results.

TABLE 1

| | Example 1 | Example 2 | Comparative Example 1 |
|---|---|---|---|
| After 50 cycles | 88% | 90% | 78% |
| After 200 cycles | 79% | 80% | 45% |

As is understood from Table 1, in Examples 1 and 2 in which the composition gradient layer with a smooth variation in composition is formed at the interface between the negative collector and the negative active material, the battery capacity maintenance ratios after 50 cycles and 200 cycles can be set to be larger than those in Comparative Example 1 in which a composition is varied abruptly at the interface, and substantially no composition gradient layer is formed.

When a negative active material thin film was formed in the same way as in Example 1 except that the deposition amount of copper was changed variously, in the case where the deposition amount of copper was set to be less than 10 nm at a thickness conversion value (chemically quantified average thickness) when only copper was sputtered, the enhancement degree of cycle characteristics was decreased to about 30% of Example 1. Thus, it is preferable that the deposition amount of copper is 50 nm or more at a thickness conversion value (chemically quantified average thickness) when only copper was sputtered.

On the other hand, when a negative active material thin film was formed in the same way as in Example 2 except that the deposition amount of copper was changed variously, in the case where the deposition amount of copper exceeds 10 μm at a thickness conversion value (chemically quantified average thickness) when only copper was vapor-deposited, the decrease in productivity and the abnormal growth of vapor-deposited particles were conspicuous. Thus, it is preferable that the deposition amount of copper is 10 μm or less at a thickness conversion value (chemically quantified average thickness) when only copper is vapor-deposited.

As described above, when a negative active material containing silicon as a main component is formed on a negative collector by a vacuum film-forming process, a film-formation surface of the negative collector is moved relatively from a first region where the main component element particles of the negative collector are deposited to a second region where silicon particles are deposited. Furthermore, in order to vary gradually the concentration of elements of particles to be deposited, a part of the first region is overlapped with a part of the second region, whereby a region (mixed film-formation region) is provided in which the main component element particles of the negative collector are mixed with silicon particles, followed by being deposited. Because of this, a composition gradient layer, in which a composition distribution of a main component element of the negative collector and silicon is varied smoothly, is formed at an interface between the negative collector and the negative active material. The composition gradient layer smoothly varies the physical characteristics at the interface between the negative collector and the negative active material. Therefore, even when silicon particles in the negative active material expand/contract during charging/discharging, the composition gradient layer alleviates the strain involved in the expansion/contraction of the silicon particles. Thus, the adhesion strength between the negative collector and the negative active material is enhanced, and consequently, cycle characteristics are enhanced as in Examples 1 and 2.

### Embodiment 2

An energy device according to Embodiment 2 of the present invention will be described.

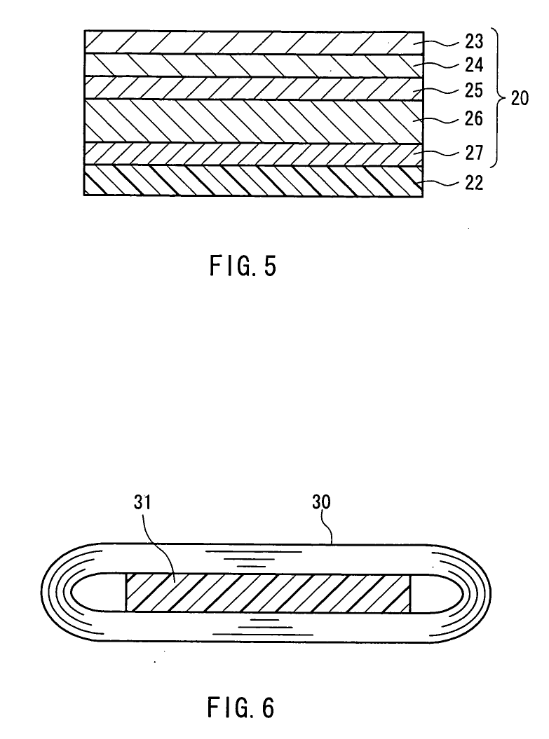

FIG. 5 shows an exemplary schematic configuration of the energy device according to Embodiment 2 of the present invention. The energy device of the present embodiment has a configuration in which a battery element 20 is laminated on a substrate 22. In the battery element 20, a positive collector 27, a positive active material 26, a solid electrolyte 25, a negative active material 24, and a negative collector 23 are formed in this order. In FIG. 5, although the substrate 22 is placed on the side of the positive collector 27 of the battery element 20, it may be placed on the side of the negative collector 23.

As the substrate 22, a flexible material, such as polyimide (PI), polyamide (PA), polyethylene naphthalate (PEN), polyethylene terephthalate (PET), or other polymer films; a stainless steel foil; a metal foil containing nickel, copper, aluminum, or other metal elements; or the like, can be used. Furthermore, silicon, glass, ceramic, plastic, or the like in various kinds of shapes also can be used, and according to the present invention, there is no particular limit to the material and shape of the substrate. The material and shape of the substrate only need to be selected appropriately in accordance with the characteristics required of the energy device.

As the positive collector 27, for example, metal such as nickel, copper, aluminum, platinum, platinum-palladium, gold, silver, titanium, or ITO (indium-tin oxide) can be used. Depending upon the final form of the energy device, in the case of placing the substrate 22 on the positive electrode side, and using a conductive material as the substrate 22, the substrate 22 is allowed to function as the positive collector 27, with the positive collector 27 being omitted.

As the positive active material 26, for example, lithium cobaltate, lithium nickelate, or the like can be used. The material for the positive active material 26 of the present invention is not limited to the above, and other materials also can be used.

As the solid electrolyte 25, a material having ion conductivity and negligible small electron conductivity can be used. Particularly, in the case where the energy device is a lithium ion secondary battery, since lithium ions are mobile ions, a solid electrolyte made of Li₃PO₄, a material (LiPON: a typical composition is Li_{2.9}PO_{3.3}N_{0.36}) obtained by mixing Li₃PO₄ with nitrogen (or replacing a part of an element of Li₃PO₄ with nitrogen), or the like is preferable due to excellent lithium ion conductivity. Similarly, a solid electrolyte made of a sulfide such as Li₂S—SiS₂, Li₂S—P₂S₅, Li₂S—B₂S₃, or the like also is effective. Furthermore, a solid electrolyte, which is obtained by doping the above-mentioned solid electrolyte with lithium halide such as LiI, or a lithium oxyacid salt such as Li₃PO₄, also is effective. The material for the solid electrolyte 25 of the present invention is not limited to the above, and other materials also can be used for the solid electrolyte 25. By using a solid electrolyte as an electrolyte, measures against leakage of liquid, which are necessary in a conventional liquid electrolyte, are not required, facilitating the miniaturization and reduction in thickness of an energy device.

As the negative active material 24, a silicon thin film containing silicon as a main component can be used. The negative active material 24 has a composition gradient layer in the vicinity of the interface with respect to the negative collector 23.

As the negative collector 23, in the same way as in the positive collector 27, for example, metal such as nickel, copper, aluminum, platinum, platinum-palladium, gold, silver, or ITO indium-tin oxide) can be used. Depending upon the final form of the energy device, in the case of placing the substrate 22 on the negative electrode side, and using a conductive material as the substrate 22, the substrate 22 can be allowed to function as the negative collector 23, with the negative collector 23 being omitted.

There is no particular limit to the product form of the energy device, and various kinds can be considered. For example, a laminate, in which the battery element 20 shown in FIG. 5 is laminated on the flexible long substrate 22, may be wound in a plate shape as shown in FIG. 6. In this case, an inner core 31 in a plate shape may be placed on an inner circumference of the winding body 30.

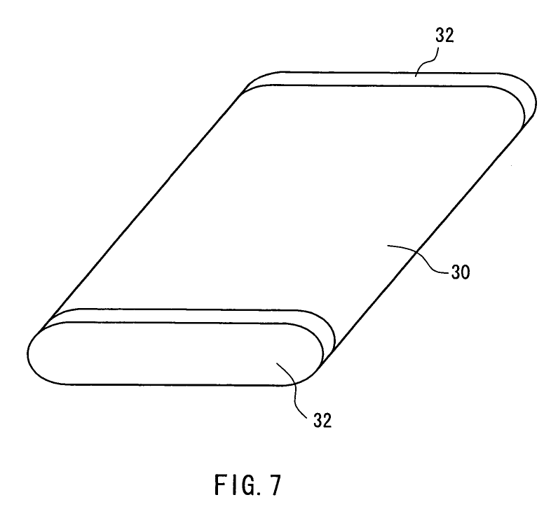

FIG. 7 is a perspective view of the plate-shaped energy device shown in FIG. 6. In FIG. 7, reference numeral 32 denotes a pair of outer electrodes provided on both ends of the winding body 30. The outer electrodes 32 can be made of various kinds of conductive materials such as nickel, zinc, tin, a solder alloy, a conductive resin, or the like. As the method for forming the outer electrodes 32, thermal spraying, plating, coating, or the like can be used. The negative collector 23 is electrically connected to one outer electrode 32, and the positive collector 27 is electrically connected to the other outer electrode 32. In this case, it is necessary that a region in a width direction (in a direction of a winding center) for forming the negative collector 23 and the positive collector 27 is patterned so that a pair of outer electrodes 32 are insulated from each other.

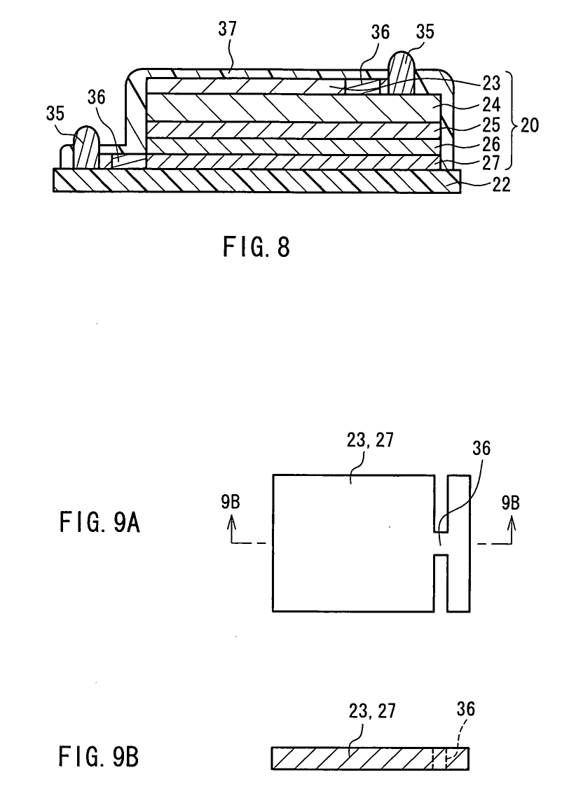

FIG. 8 is a cross-sectional view showing another product form of the energy device. In FIG. 8, reference numeral 35 denotes a pair of outer electrodes. The negative collector 23 is electrically connected to one outer electrode 35, and the positive collector 27 is electrically connected to the other outer electrode 35. The material and method for forming the outer electrodes 35 are similar to those of the outer electrode 32 shown in FIG. 7.

Reference numeral 36 denotes fuse portions provided in the negative collector 23 at the vicinity of a connected portion to the outer electrode 35, and in the positive collector 27 at the vicinity of a connected portion to the outer electrode 35. The fuse portion 36 functions as a safety apparatus for causing a fuse blowout, when an overcurrent flows, to shut off the overcurrent, thereby previously preventing ignition. In the present embodiment, although the fuse portions 36 are provided in the negative collector 23 and the positive collector 27, the fuse portion 36 may be provided in either one of them.

FIG. 9A is a plan view showing an example of the fuse portion 36. FIG. 9B is a cross-sectional view seen in an arrow direction taken along a line 9B-9B in FIG. 9A. The collectors 23 and 27 respectively are provided with a pattern so that the width of a portion through which a current flows is narrow, whereby the fuse portions 36 are formed. When an overcurrent flows, the fuse portions 36 generate heat due to Joule's heat, causing a fuse blowout, thereby shutting off the overcurrent. Thus, a serious situation such as ignition can be avoided. The configuration of the fuse portion 36 is not limited to that shown in FIGS. 9A and 9B. For example, the fuse portions 36 may be configured by partially reducing the thickness of the negative collector 23 and the positive collector 27. Alternatively, the fuse portions 36 may be formed by forming a different kind of material having a large temperature coefficient of electric resistance in a particular pattern, respectively, in the negative collector 23 and the positive collector 27. The temperature coefficient of electric resistance of the different kind of material is larger than those of the negative collector 23 and the positive collector 27. Therefore, when the temperature of the fuse portions 36 is increased slightly at a time of an overcurrent, the resistance of the different kind of material is increased rapidly. Thus, a current flows concentratedly in the materials for the negative collector 23 and the positive collector 27 other than the different kind of material in the fuse portions 36, and consequently, the fuse portions 36 generate heat due to Joule's heat, causing a fuse blowout, thereby shutting off an overcurrent.

In FIG. 8, reference numeral 37 denotes a protective layer provided for the purpose of mechanical protection, enhancement of moisture resistance, prevention of interlayer peeling, and the like. Examples of the material for the protective layer 37 include, but are not limited to, a surface treatment agent such as silane coupling agent, light-curable or thermosetting resin, metal, a metal oxide, a metal nitride, and the like. As the method for forming the protective layer 37, a wet process such as coating, dipping (soaking), spraying, etc.; or a dry process such as vapor deposition, sputtering, etc. can be adopted. Furthermore, the protective layer 37 may be composed of a multi-layered composite film made of different kinds of materials or the same kind of material. The protective layer 37 can be formed on an outer surface of the energy device excluding the outer electrodes 35. Depending upon the material for the substrate 22, the protective layer 37 may not be formed on the surface of the substrate 22 as shown in FIG. 8.

Furthermore, the energy device may be configured by laminating a required number of the battery elements 20 repeatedly.

### EXAMPLES 3 AND 4, AND COMPARATIVE EXAMPLE 2

Examples corresponding to Embodiment 2 will be described.

Nickel (thickness: 0.5 μm) as the positive collector 27, and lithium cobaltate (thickness: 8 μm) as the positive active material 26 were laminated on a polyimide film (thickness: 25 μm) as the substrate 22, respectively by vacuum vapor deposition, and furthermore, the lithium phosphate-based solid electrolyte 25 (thickness: 2 μm) was laminated on the positive active material 26 by vacuum vapor deposition.

Thereafter, silicon and copper were vapor-deposited successively on the surface of the solid electrolyte 25, whereby the negative active material 24 made of a silicon thin film (thickness: about 3 μm) and the negative collector 23 made of a copper thin film (thickness: about 1 μm) were formed. This will be described in detail later.

Thus, a band-shaped laminate having a laminated configuration shown in FIG. 5 was obtained.

The laminate thus obtained was wound in a plate shape, and a pair of outer electrodes 32 were formed so as to be electrically connected to the positive collector 27 and the negative collector 23, respectively, whereby a plate-shaped lithium ion secondary battery as shown in FIG. 7 was obtained.

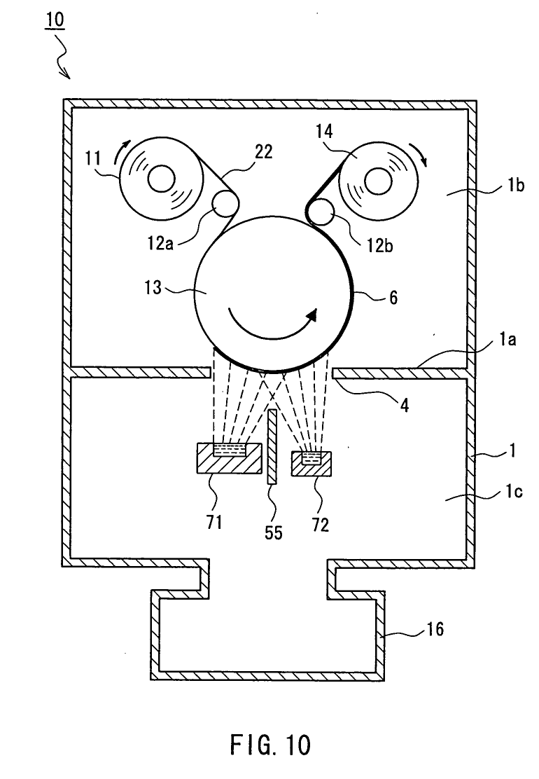

A method for forming the negative active material 24 and the negative collector 23 will be described with reference to FIG. 10.

An apparatus shown in FIG. 10 is different from that shown in FIG. 1, in that a negative active material vapor-deposition source 71 and a negative collector vapor-deposition source 72 are placed in the thin film forming chamber 1c, in place of the sputtering film-forming source 51 and the auxiliary sputtering film-forming source 52. In FIG. 10, the same components as those in FIG. 1 are denoted with the same reference numerals as those therein, and the description thereof will be omitted.

The band-shaped substrate 22 with the positive collector 27, the positive active material 26, and the solid electrolyte 25 formed thereon is unwound from the unwinding roll 11, transported successively by the transportation roll 12a, the can roll 13, and the transportation roll 12b, and taken up around the take-up roll 14. During this process, particles (film-forming particles; hereinafter, referred to as “evaporated particles”) such as atoms, molecules, or a cluster generated from the negative active material vapor-deposition source 71 and the negative collector vapor-deposition source 72 pass through the mask 4 of the partition wall 1a, and adhere to the surface of the solid electrolyte 25 of the substrate 22 running on the can roll 13, thereby forming the thin film 6. The negative active material vapor-deposition source 71 and the negative collector vapor-deposition source 72 are placed so as to be opposed to the substrate 22 from an upstream side to a downstream side in the transportation direction of the substrate 22. The mobile shielding plate 55 can move in a radius direction with respect to a rotation central axis of the can roll 13. The distance of the mobile shielding plate 55 from an outer circumferential surface of the can roll 13 was adjusted so that a part of evaporated particles from the negative active material vapor-deposition source 71 and a part of evaporated particles from the negative collector vapor deposition source 72 are mixed with each other in the vicinity of the outer circumferential surface of the can roll 13. Accordingly, first, the evaporated particles from the negative active material vapor deposition source 71 mainly are deposited on the surface of the solid electrolyte 25 of the substrate 22; thereafter, the ratio of the evaporated particles from the negative collector vapor deposition source 72 is increased gradually; and finally, the evaporated particles from the negative collector vapor deposition source 72 mainly are deposited.

In Examples 3 and 4, using the above-mentioned apparatus, silicon was evaporated from the negative active material vapor-deposition source 71 to form the negative active material 24 (thickness: about 3 μm), and copper was evaporated from the negative collector vapor-deposition source 72 to form the negative collector 23 (thickness: about 1 μm). Consequently, a composition gradient layer, in which a composition distribution of silicon and copper is varied smoothly, is formed at the interface between the negative active material 24 and the negative collector 23.

In Example 3, the distance of the mobile shielding plate 55 from the outer circumferential surface of the can roll 13 is decreased, whereby the mixing between the silicon particles from the negative active material vapor-deposition source 71 and the copper particles from the negative collector vapor-deposition source 72 is reduced.

In Example 4, the distance of the mobile shielding plate 55 from the outer circumferential surface of the can roll 13 is increased, whereby the mixing between the silicon particles from the negative active material vapor-deposition source 71 and the copper particles from the negative collector vapor-deposition source 72 is increased.

In comparative Example 2, silicon was evaporated using only the negative active material vapor-deposition source 71, without using the negative collector vapor-deposition source 72, whereby the negative active material 24 (thickness: about 3 μm) was formed, and the substrate 22 was first taken up around the take-up roll 14. Then, the substrate 22 was placed on the unwinding roll 11, and copper was evaporated on the surface of the negative active material 24 using only the negative collector vapor-deposition source 72, without using the negative active material vapor-deposition source 71, whereby the negative collector 23 (thickness: about 1 μm) was formed.

As a result of measuring the Auger depth profiles of Examples 3 and 4, and Comparative Example 2, in Examples 3 and 4 in which continuous mixed film-formation using two film-forming sources was performed, compared with Comparative Example 2, a composition gradient layer, in which silicon and copper were mixed and a composition distribution of these elements was varied smoothly, was formed at the interface between the negative active material 24 and the negative collector 23. The following was confirmed: by placing the negative active material vapor-deposition source 71 and the negative collector vapor-deposition source 72 adjacent to each other so that parts of the evaporated particles from the respective sources were mixed with each other, thereby forming the negative active material 24 and the negative collector 23 continuously in this order, a composition gradient layer was formed at the interface between negative active material 24 and the negative collector 23.

The lithium ion secondary batteries obtained in Examples 3 and 4, and Comparative Example 2 were subjected to a charging/discharging cycle test at a test temperature of 20° C., a charging/discharging current of 3 mA/cm², and a charging/discharging voltage range of 4.2 V to 2.5 V. The ratios of the discharging capacity after 50 cycles and 200 cycles, with respect to the initial discharging capacity, were obtained as battery capacity maintenance ratios (cycle characteristics). Table 2 shows the results.

TABLE 2

| | | | Comparative |
|---|---|---|---|
| | Example 3 | Example 4 | Example 2 |
| After 50 cycles | 82% | 79% | 54% |
| After 200 cycles | 67% | 65% | 26% |

As is understood from Table 2, in Examples 3 and 4 in which a smooth composition gradient layer is formed at the interface between the negative collector 23 and the negative active material 24, the battery capacity maintenance ratios after 50 cycles and 200 cycles are higher than those in Comparative Example 2 in which a composition is varied abruptly at the interface, and a composition gradient layer is not formed substantially.

In the vicinity of the interface between the negative active material 24 and the negative collector 23, the distance in a thickness direction from a point where the signal intensity of silicon has a peak value in the vicinity of the interface to a point where the signal intensity of silicon is decreased to ½ of the peak value was 2 μm in Example 3. This is only an example, and cycle characteristics were enhanced even in the case where the distance was, for example, 100 nm.

As described above, when the negative active material containing silicon as a main component and the negative collector are formed on an electrolyte by a vacuum film-forming process, a film-formation surface is moved relatively from a first region where silicon particles are deposited to a second region where element particles for forming the negative collector are deposited. Furthermore, in order to vary gradually the concentration of elements of particles to be deposited, a part of the first region is overlapped with a part of the second region, whereby a region (mixed film-formation region) is provided in which silicon particles are mixed with element particles for forming the negative collector, followed by being deposited. Because of this, a composition gradient layer, in which a composition distribution is varied smoothly, is formed at an interface between the negative active material and the negative collector. The composition gradient layer smoothly varies the physical characteristics at the interface between the negative active material and the negative collector. Therefore, even when silicon particles in the negative active material expand/contract during charging/discharging, the composition gradient layer alleviates the strain involved in the expansion/contraction of the silicon particles. Thus, the adhesion strength between the negative active material and the negative collector is enhanced, and consequently, cycle characteristics are enhanced as in Examples 3 and 4.

In the above-mentioned Examples 1 and 2, the negative active material is formed by sputtering or vapor deposition, and in Examples 3 and 4, the negative active material and the negative collector are formed by vapor deposition. However, the present invention is not limited thereto. Other vacuum film-forming processes such as CVD may be used, and even in this case, the similar effects can be obtained.

The copper foil used as the negative collector in Examples 1 and 2 may be subjected to surface treatment. As the surface treatment that can be used for the copper foil, zinc plating; alloy plating of zinc and tin, copper, nickel or cobalt; formation of a covering layer, using an azole derivative such as benzotriazole; formation of a chromium-containing coating film, using a solution containing chromic acid or dichromate; or a combination thereof can be used. Alternatively, in place of a copper foil, another substrate provided with a copper covering may be used. The above-mentioned surface treatment may be performed with respect to the surface of the copper covering.

Although not mentioned in the description of the above-mentioned embodiments and examples, it is desirable that a negative active material thin film is formed in the atmosphere of inert gas or nitrogen. An atmospheric gas may be introduced toward a film-formation surface (the opening of the mask 4 in the above-mentioned examples). Alternatively, the atmospheric gas may be introduced so as to spread through the entire vacuum tank (the thin film forming chamber 1c in the above-mentioned examples). In terms of efficiency, it is preferable that the atmospheric gas is introduced toward the film-formation surface.

By forming a negative active material thin film in such an atmospheric gas, silicon columnar particles adjacent to each other in a direction parallel to the film-formation surface can be prevented from being integrated and growing to enlarge the particle diameter of silicon. Consequently, the cycle characteristics can be suppressed from being degraded due to the extreme expansion/contraction of silicon particles during charging/discharging. According to the experiment by the inventors of the present invention, although a graph showing detailed experimental results is omitted, by forming a negative active material thin film in the above-mentioned gas atmosphere, the number of charging/discharging cycles for decreasing the battery capacity maintenance ratio of the energy device to 80% was increased, for example, by 15 to 50%.

The preferable introduction amount of gas is set in accordance with the film-formation condition of the negative active material thin film, particularly, in accordance with the thin film deposition rate R (nm/s). For example, in the case of introducing gas toward the film-formation surface, a gas introduction amount Q (m³/s) per film-formation width of 100 mm is preferably in a range of 1×10⁻¹⁰×R to 1×10⁻⁶×R, and more preferably in a range of 1×10⁻⁹×R to 1×10⁻⁷×R. When the gas introduction amount is too small, the above-mentioned effects cannot be obtained. In contrast, when the gas introduction amount is too large, the deposition rate of the negative active material thin film is decreased.

As the gas to be used, argon is most preferable in terms of practicality and conspicuousness of the above-mentioned effects.

Furthermore, it may be preferable that a part of silicon contained in the negative active material thin film is an oxide. In the case where the content of silicon in the negative active material thin film is large, and the battery capacity is large, the degree of expansion/contraction of the silicon particles during charging/discharging may be increased, and cycle characteristics may be degraded. When the negative active material thin film contains an oxide of silicon, since the oxide of silicon expands/contracts less during charging/discharging, the expansion/contraction of the silicon particles during charging/discharging can be suppressed, and cycle characteristics can be enhanced. For example, it is preferable that the negative active material thin film is formed so that 20 to 50% of silicon contained in the negative active material thin film becomes an oxide. According to the experiment by the inventors of the present invention, although a graph showing detailed experimental results is omitted, by allowing the negative active material thin film to contain an oxide of silicon, the number of charging/discharging cycles for decreasing the battery capacity maintenance ratio of the energy device to 80% was increased, for example, by 10 to 140% (which depends upon the negative active material thin film).

A part of silicon can be formed into an oxide, for example, by introducing oxygen-based gas in the vicinity of the film-formation surface, and allowing the gas to react with silicon atoms, during formation of the negative active material thin film in a vacuum atmosphere. In order to enhance reactivity, it is effective to use ozone, and provide energy by plasma, a substrate potential, or the like.

The preferable introduction amount of gas is set in accordance with the film-formation condition of the negative active material thin film, particularly, in accordance with the thin film deposition rate R (nm/s). For example, in the case where gas is introduced toward a film-formation surface, a gas introduction amount P(m³/s) per film-formation width of 100 mm is preferably in a range of 1×10⁻¹¹×R to 1×10⁻⁵×R, more preferably in a range of 1×10⁻¹⁰×R to 1×10⁻⁶×R, and most preferably in a range of 1×10⁻⁹×R to 1×10⁻⁷×R. It should be noted that the gas introduction amount P is not limited to the above, depending upon the facility form and the like. When the gas introduction amount is too small, the above-mentioned effects cannot be obtained. In contrast, when the gas introduction amount is too large, the entire negative active material thin film becomes an oxide, which decreases a battery capacity.

The applicable field of the energy device of the present invention is not particularly limited. For example, the energy device can be used as a secondary battery for thin and lightweight portable equipment of a small size.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

1. A method for producing an energy device comprising forming a negative active material thin film, containing silicon as a main component, on a collector by a vacuum film-forming process,
wherein, with respect to an auxiliary film-forming source containing a main component element of the collector and a negative active material film-forming source for forming the negative active material thin film, placed adjacent to each other so that parts of film-forming particles from the respective sources are mixed with each other, the collector is moved relatively from the auxiliary film-forming source side to the negative active material film-forming source side.

2. The method for producing an energy device according to claim 1, wherein the vacuum film-forming process is vacuum vapor deposition.

3. The method for producing an energy device according to claim 1, wherein the main component element of the collector is copper.

4. The method for producing an energy device according to claim 1, wherein a part of silicon contained in the negative active material thin film is an oxide.

5. An energy device comprising a collector and a negative active material thin film containing silicon as a main component,
wherein, with respect to an auxiliary film-forming source containing a main component element of the collector and a negative active material film-forming source for forming the negative active material thin film, placed adjacent to each other so that parts of film-forming particles from the respective sources are mixed with each other, the collector is moved relatively from the auxiliary film-forming source side to the negative active material film-forming source side, whereby the negative active material thin film is formed on the collector by a vacuum film-forming method.

6. A method for producing an energy device comprising forming a negative active material thin film, containing silicon as a main component, and a collector on an electrolyte formed on a substrate by a vacuum film-forming process,
wherein, with respect to a negative active material film-forming source for forming the negative active material thin film and a collector film-forming source for forming the collector, placed adjacent to each other so that parts of film-forming particles from the respective sources are mixed with each other, the substrate is moved relatively from the negative active material film-forming source side to the collector film-forming source side.

7. The method for producing an energy device according to claim 5, wherein the vacuum film-forming process is vacuum vapor deposition.

8. The method for producing an energy device according to claim 5, wherein the collector film-forming source contains copper as a main component.

9. The method for producing an energy device according to claim 5, wherein a part of silicon contained in the negative active material thin film is an oxide.

10. An energy device comprising an electrolyte, a negative active material thin film containing silicon as a main component, and a collector,
wherein, with respect to a negative active material film-forming source for forming the negative active material thin film and a collector film-forming source for forming the collector, placed adjacent to each other so that parts of film-forming particles from the respective sources are mixed with each other, the electrolyte is moved relatively from the negative active material film-forming source side to the collector film-forming source side, whereby the negative active material thin film and the collector are formed on the electrolyte by a vacuum film-forming method.
